(19) United States
(12) Patent Application Publication
(10) Pub. No.: US 2020/0142738 A1
(43) Pub. Date: May 7, 2020

(54) Systems And Methods For Control Flow Integrity In System Management Mode (SMM)

(71) Applicant: DELL PRODUCTS L.P., Round Rock, TX (US)

(72) Inventors: Nicholas D. Grobelny, Austin, TX (US); Ricardo L. Martinez, Leander, TX (US); Girish S. Dhoble, Austin, TX (US); Abeye Teshome, Austin, TX (US)

(21) Appl. No.: 16/182,192

(22) Filed: Nov. 6, 2018

(51) Int. Cl. G06F 9/50; G06F 9/48

(52) U.S. Cl. CPC G06F 9/50; G06F 9/4812

(57) ABSTRACT

Systems and methods are provided that may be implemented to control flow integrity during systems management mode (SMM). The systems and methods may be implemented to restrict access by a given SMI function to specific regions of dynamic system memory by blocking unauthorized access to data or code regions of the system memory that are not needed by the SMI function so as to protect the rest of the system memory and system.

### FIELD

This invention relates generally to information handling systems and, more particularly, to system management mode (SMM) in information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

All system management interrupt (SMI) functions executed by a central processing unit (CPU) of an information handling system have access to all memory pages, including needed pages and other memory pages that that should not be accessed. This includes access to other SMI function code without any restrictions even if there is no need to have this open access. Also, all functions have access to all the SMM data region of system management memory (SMRAM) of host memory. All the SMI functions and the data accessed by the SMI functions are in plain text (i.e., not encrypted)

FIG. 1A illustrates a conventional method for handling a SMI. As shown in FIG. 1, upon SMI entry in step 50, the host CPU 11 of the information handling system 10 fetches Function A which is shown now running in FIG. 1A. As shown by the paths of the arrows in FIG. 1, Function A is given access to memory pages within system management mode (SMM) code region 13 and SMM data region 14 of host SMM memory 17 (also known as SMRAM), as well as host kernel/user data region 15, of host system memory 12. As shown Function A has access to SMM data region 14 that contains Data X (via path 1) and Data Y (via path 2) and can read, modify and erase Data X and Data Y. Function A can also access, read, modify, and erase Data Z of host kernel/user data region 15 (via Path 3), other user Data of host kernel/user data region 15 (via Path 4), or even code in SMM code region 13 (via Path 5). Function A should have access to data of paths 1 and 2, since they are necessary for normal operation. However, allowing Function A to unnecessarily access data of paths 3, 4, and 5 could have unintended consequences (e.g., malware could be written to exploit these paths to compromise data or code on the system). Further, once Function A calls Library E in step 60, control is passed from Function A to the other Library E (via Path 6), at which time it is also possible for Library E to pass control unintentionally to Library F (path 7), with similar consequences.

FIG. 1B illustrates conventional methodology 20 for processing and executing a request for access to a SMI function in SMM code region 13. Conventional methodology 20 occurs during a SMM mode that was previously triggered in the OS in response to a SMI. As shown, methodology 20 begins in step 22 where the system host CPU may receive a request from a calling process (e.g., application, etc.) to access a needed SMI function. Next, in step 24, the operating system (OS) on the host CPU authenticates the calling process by checking whether the process has administrative level privileges, and fetches and loads the requested SMI function in step 26. The SMI function terminates after being executed, and methodology 20 resumes to the OS in step 28.

Process authentication by the OS is known, together with execution and returning of SMI functions. Control flow integrity exists for software contexts that do not include SMM. It is known to use CPU firmware microcode to allow page-level control for SMM. CPU firmware microcode defines tables for general bounding of SMM within system memory, i.e., it is known to use CPU embedded firmware microcode to allow page-level control for SMM by allowing SMM access to be restricted to only those page ranges inside of SMM, but the CPU embedded firmware microcode does not have authority to control functionality within SMM. This CPU embedded firmware microcode logic executes every time a SMM instruction runs, checks CPU registers that contain memory bounds to determine if the instruction is trying to access outside of the allowed bounds for SMM operations, and raises an error if the instruction is trying access something outside the allowed bounds. Operating system table memory management and paging are utilized to limit access to page ranges outside of SMM, but does not have authority to control functionality within SMM.

### SUMMARY

Disclosed herein are systems and methods that may be implemented to control flow integrity during systems management mode (SMM), e.g., to protect functions from each other within SMM, and/or to protect functions and data outside SMM from rogue or unexpected behavior within SMM. In one embodiment, the disclosed systems and methods may be implemented during SMM mode to restrict access by a given SMI function to specific regions of dynamic system memory by blocking unauthorized access to data or code regions of the system memory that are not needed by the function so as to protect the rest of the system memory and system, e.g., from any malicious code attempting to use SMM for privilege escalation. In one exemplary embodiment, a function-defined memory page table or other data listing may be created to describe a permissions policy (e.g., such as a look-up table) that identifies those specific system memory page ranges for which different SMI functions and SMI libraries (i.e., code shared between multiple SMI functions) are to be permitted access. In a further embodiment, hardware memory page management may be utilized to provide control flow integrity for SMM according to the permissions policy. For example, CPU hardware (e.g., embedded CPU microcode or functional logic) may be utilized to block unauthorized access by a given SMI function or SMI library to specific data or code regions of system memory that are not identified as being permitted (e.g., in the case where they are not needed) for the given function or library.

In one embodiment, one or more look up tables may be created during basic input/output system (BIOS) build or compile time (e.g., by engineering or otherwise defined during BIOS build or compile time) and installed on an information handling system during system manufacturing. These created look up tables may define which specific memory regions that different individual functions are allowed (or disallowed) to access. At system boot time, these tables may be loaded in hardware (e.g., CPU hardware), and when SMI is executed at runtime, the lookup table/s may be referenced by SMM hardware to control permissions for each function or library.

In one respect, disclosed herein is an information handling system, including: a system memory; and a programmable integrated circuit coupled to the system memory, the programmable integrated circuit being programmed to operate in a system management mode (SMM) to retrieve and execute at least one SMI function/library from the system memory upon entry into the SMM. The programmable integrated circuit may be programmed to control access by the executing SMI function/library to data or code regions of the system memory according to a data permission listing that identifies one or more permitted system memory page ranges for which the executing SMI function/library is permitted access, the permitted system page ranges including only a portion of all SMI functions/libraries held in the system memory.

In another respect, disclosed herein is a method, including operating a programmable integrated circuit of an information handling system in a system management mode (SMM) to: retrieve and execute at least one SMI function/library from a system memory of the information handling system upon entry into the SMM; and control access by the executing SMI function/library to data or code regions of the system memory according to a data permission listing that identifies one or more permitted system memory page ranges for which the executing SMI function/library is permitted access, the permitted system page ranges including only a portion of all SMI functions/libraries held in the system memory.

### BRIEF DESCRIPTION OF THE DRAWINGS

FIG. 1A illustrates a conventional method for handling a SMI.

FIG. 1B illustrates conventional methodology for processing and executing a request for access to a SMI function.

FIG. 2 is a block diagram of an information handling system according to one exemplary embodiment of the disclosed systems and methods.

FIG. 3 illustrates methodology according to one exemplary embodiment of the disclosed systems and methods.

FIG. 4 illustrates methodology according to one exemplary embodiment of the disclosed systems and methods.

### DESCRIPTION OF ILLUSTRATIVE EMBODIMENTS

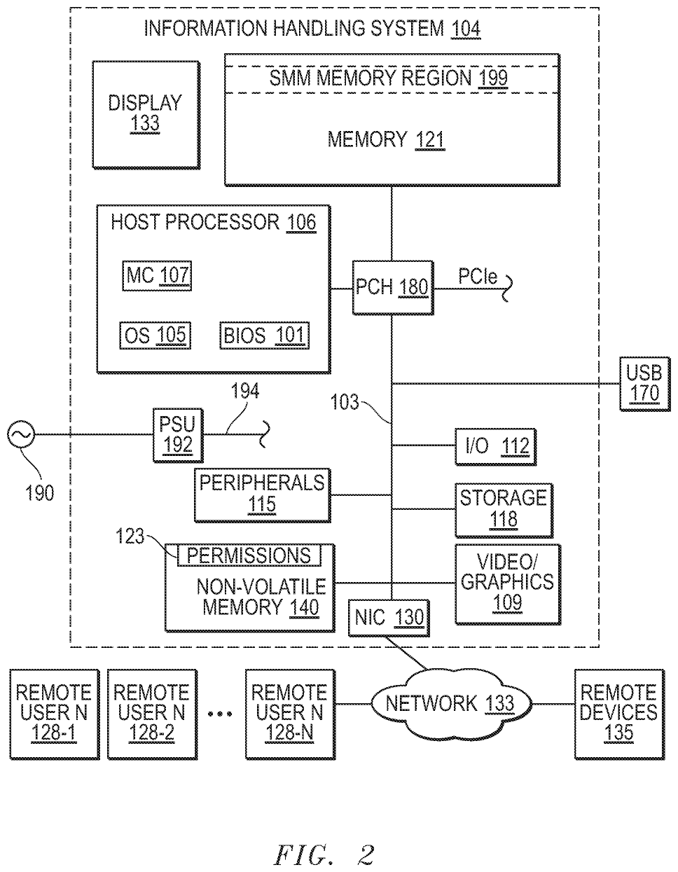

FIG. 2 is a block diagram of an information handling system 104 (e.g., such as a server, desktop computer, laptop, notebook, etc.) as it may be configured according to one exemplary embodiment to control flow integrity during SMM mode. As shown, system 104 may include one or more host processing device/s 106 (e.g., AMD or Intel-based CPU such as Itanium or any other type of suitable host processing device), one or more buses or communication media 103 (e.g., PCIe bus, USB, SMBus, SATA, other appropriate data buses such as memory bus, etc.), video/graphics hardware 109 (e.g., video adapter or graphics processor unit), storage 118 (e.g., solid state drive (SSD), hard disk drive and/or optical drive, etc.), system memory 121 (e.g., volatile memory such as dynamic random access memory “DRAM”), local input/output (I/O) 112, peripherals 115 (e.g., keyboard, mouse, etc.), non-volatile memory 140 (e.g., such as Flash memory), and remote access controller (RAC) (not shown). Examples of a remote access controller include an integrated Dell Remote Access Controller (iDRAC) available from Dell Technologies Inc. of Round Rock, Tex., etc.). In one embodiment, the video/graphics hardware 109 (and/or integrated graphics within host processing device 106) may control a video display 133 for display of information (e.g., GUI) to a local user, and the local user may provide user input via peripherals 115.

In the exemplary embodiment of FIG. 2, host processing device/s 106 is configured to load and run a Basic Input Output System (BIOS) 101 (e.g., UEFI firmware) and host OS 105 (e.g., Windows-based OS, Linux-based OS, etc.), among others. BIOS 101 includes SMI functions and SMI libraries (i.e., code shared between multiple SMI functions) that may be stored with BIOS 101 on non-volatile memory 140. Host processing device/s 106 also includes embedded non-volatile firmware hardware microcode 107 that is that is executed by host processing device/s 106 during boot and run-time. Embedded microcode 107 may be furnished, for example, as part of embedded CPU hardware of a CPU provided by chip manufacturers such as Intel, AMD, etc. As described further herein, embedded hardware microcode 107 includes hardware page management functionality that is utilized by the disclosed systems and methods for the disclosed SMM memory access control. Embedded hardware microcode 107 may be mapped during BIOS pre-boot to a function/library permissions table 123 stored in non-volatile memory 140 together with BIOS 101. In an alternate embodiment, control of flow integrity and SMM memory access control may be managed in a similar manner with an SMM “handler” routine that controls execution flow in software rather than with hardware microcode 107 of host processing device (e.g., CPU) hardware.

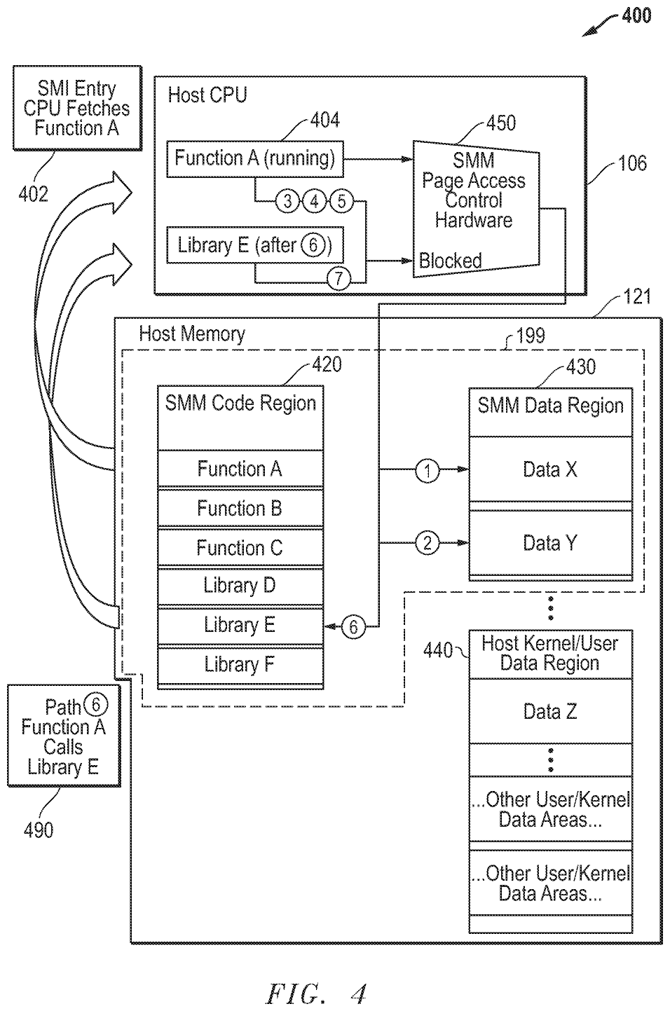

Bus/es 103 provides a mechanism for the various components of system 104 to communicate and couple with one another. As shown, host processing device 106 may be coupled in an embodiment to bus/es 103 via an embedded platform controller hub (PCH) 180 and may be coupled to facilitate input/output functions for the processing device/s 106 with various internal system components of information handling system 104 through bus/es 103 such as PCI, PCIe, SPI, USB, low pin count (LPC), etc. Examples of such system components include, but are not limited to, NVRAM, BIOS SPI Flash, NVDIMMS, DIMMS, PCIe Devices, etc. The PCH 180 is directly coupled to system memory 121 as shown. System memory 121 includes memory pages of a SMM code region 420 and a SMM data region 430 that are contained within a SMM region 199 (also known as SMRAM) as further illustrated in FIG. 4.

In one embodiment, host processing device/s 106 may be an in-band processing device configured to run a host operating system (OS) 105. Besides memory 121 (e.g., random access memory “RAM”), processor 106 may include cache memory for storage of frequently accessed data. Information handling system 104 may also include a network access card (NIC) 131 that is communicatively coupled to network 133 (e.g., Internet or corporate intranet) as shown to allow various components of system 104 to communicate with external and/or remote device/s 135 across network 133. Other external devices, such as an external universal serial bus (USB) device 170 may be coupled to processing device/s 106 via bus/es 103. In this embodiment, information handling system 104 also includes power supply unit (PSU) 192 that is coupled to receive power from AC mains 190 and to perform appropriate power conversion and voltage regulation to produce regulated internal power 194 for use by other power-consuming components of system 104. System 104 may also include a baseboard management controller (BMC) (not shown). As shown, in the embodiment of FIG. 2 the host system 104 may optionally provide access to a plurality of remote users 128-1 through 128-N, although access may be provided to a single user 128 in other embodiments. In this regard, remote users may manage, administer, use, and/or access various resources of host system 104 (e.g., either native or virtual) from a remote location, e.g., via network 133 and/or other suitable communication medium or media.

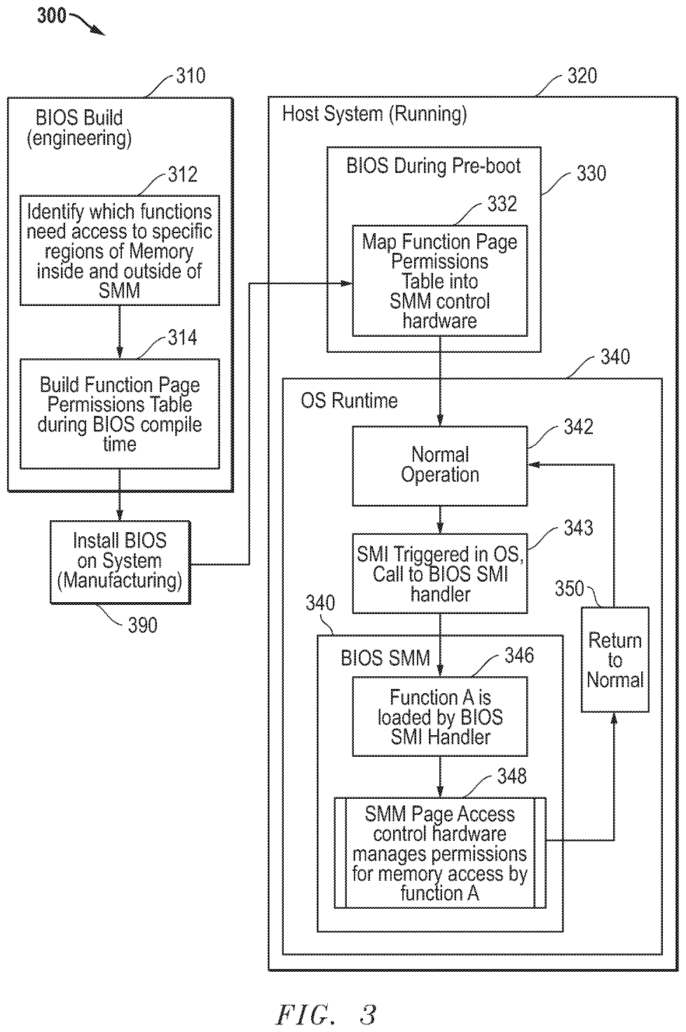

FIG. 3 illustrates methodology 300 for creating and deploying a data listing (e.g., a look up table) on an information handling system 100 according to one exemplary embodiment of the disclosed systems and methods. As shown, methodology 300 starts with BIOS build steps 310 which may be performed, for example, during system engineering before manufacture of system 100. In this embodiment, BIOS build steps 310 include step 312 in which individual SMI functions and/or libraries are identified that require access to specific regions of system memory 121, both inside and outside of SMM memory regions 199. BIOS build step 312 is followed by step 314 in one or more memory page permissions look up table/s 123 are built during BIOS compile time and included as part of the system BIOS 101 to be installed on the system 100. Table 1 below shows an example of a memory page permissions look up table/s 123 which may be built in step 314 to correspond to the needs of particular SMI functions and libraries, and may in one embodiment include all SMI functions and libraries to be installed in system memory 121 during system operation.

TABLE 1
Memory Page Permissions Table

| Function | Permissions for Function |
|---|---|
| Identification | (allowed memory ranges) |
| Function A | Function A, Data X, Data Y, Library E |
| Function B | Function B, Data Z |
| Function C | Function C, Data Y |
| Library D | Library D |
| Library E | Library E |
| Library F | Library F |

As shown in Table 1, different access permissions may be given to different functions, to allow the functions to be protected from each other. For example, a particular function may be provided for alerting on high CPU temperature and taking actions like turning on or controlling speed of processor cooling fans. Such a particular function may be given permission by a memory page permissions look up table 123 for access to the CPU temperature sensor data and to a separate processor fan management function.

Next, in step 390, BIOS 101 with the memory page permissions look up table/s 123 is installed during system manufacturing (e.g., at the factory or assembly plant). In one embodiment, BIOS 101 may be stored in system non-volatile and electronically programmable memory 140 or in any other suitable non-volatile memory of system 100 such as system storage 118. The system firmware (e.g., BIOS 101) installed at this time may also include SMI handlers that are invoked in response to an SMI.

Still referring to FIG. 3, steps 320 occur upon each system startup and pre-boot 330 to run time 340. In one embodiment, the SMM code stored in non-volatile memory 140 or other non-volatile storage may be copied to the SMM memory region 199 during steps 330. In one embodiment, SMI functions/libraries and data may be loaded into SMM memory region 199 of system memory 121 as part of BIOS 101 upon system startup and booting. During runtime, SMI functions/libraries may be fetched (and SMM data accessed) from SMM memory region 199 as needed by host processing device 106 for execution.

Steps 330 also include step 332 where function/libraries permission table/s 123 is mapped into embedded hardware microcode 107 of host processor 106 together with information such as desired configuration of memory page permissions table/s 123 and logic of how to read these table/s 123 upon SMM initialization. In one embodiment, memory page permissions table/s 123 may be loaded into data structures of SMM volatile memory 199 for access by embedded hardware microcode 107 and use in SMM at runtime. Alternatively, embedded hardware microcode 107 may access memory page permissions table/s 123 directly from non-volatile memory 140. In yet another embodiment, memory page permissions table/s 123 may be loaded directly into hardware in any suitable manner (e.g., registers, internal random access memory “RAM”, microcode, etc.) of host processing device 106, e.g., in a case where there is hardware logic available to perform page table management.

Steps 340 are performed after boot and during operating system (OS) runtime, and include non-SMM normal host processor operations 342 (e.g., user application execution) that occur until a systems management interrupt (SMI) is triggered in the OS 105 and a call occurs to the BIOS SMM handler in step 343. An SMI may be generated via a hardware interrupt event independent of code execution, e.g., by assertion of an interrupt pin (e.g., the SMI #) into the host processor 106. In one embodiment, an SMI may also be invoked by software via execution of an instruction, e.g., an instruction that writes an I/O port or address range (e.g., which a special value) that is recognized by the system as making a request to trigger an SMI.

BIOS SMM steps 344 occur upon the triggering of the SMI of step 343, at which time the BIOS SMM handler loads a function/s (e.g., SMI function A) onto host processor 106 that corresponds to the particular SMI triggered in step 343 from SMM volatile memory region 199. Next, in step 348, SMM memory page access control hardware manages permissions for memory access by Function A as further described in relation to FIG. 4. After step 348 is completed and SMM mode is exited, methodology 300 returns via step 350 to normal OS runtime operation of step 342.

FIG. 4 illustrates methodology for handling a SMI according one exemplary embodiment disclosed herein. As shown in FIG. 4, upon occurrence of SMI entry in step 402, the host processor 106 fetches Function A which is now running in step 404. At this time, SMM memory page access control hardware manages permissions for memory access by Function A according to memory page permissions table/s 123 (which only permits access by Function A to Function A, Data X, Data Y, Library E). In this way, every time a SMM mode is entered permissions specific to those given functions required by the current particular SMM may be configured, e.g., depending on the CPU need and use context.

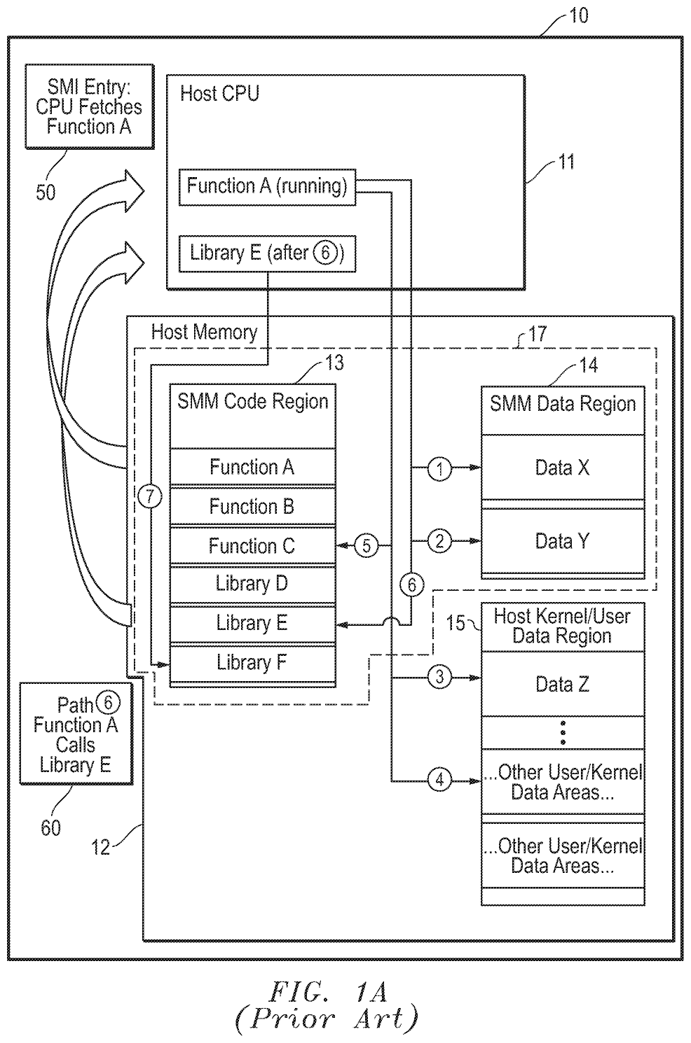

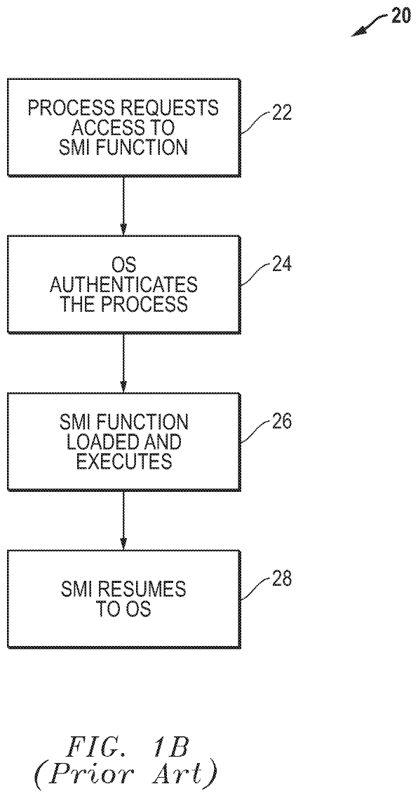

Accordingly, as shown by the arrows of paths 1, 2 and 6 in FIG. 4, Function A is only given access by SMM memory page access control hardware 450 to Library E within SMM code region 420, and to Data X and Data Y of SMM data region 430. In contrast to conventional methodology, Paths 3, 4, 5 (corresponding to the allowed paths of conventional methodology of FIG. 1A) are blocked by SMM memory page access control hardware 450 as shown according to memory page permissions table/s 123, meaning that Function A is allowed no access to other SMI functions of SMM code region 420 or to host kernel/user data regions 440 of system memory 121. Thus, Function A cannot access, read, modify, and erase Data Z of host kernel/user data region 15 (via Path 3), other user Data of host kernel/user data region 15 (via Path 4), or code in SMM code region 13 (via Path 5) in contrast to the case with conventional methodology of FIG. 1A. This prevents unintended consequences by blocking malware from being written to exploit these paths 3, 4 and 5 to compromise data or code on the system 100.

As shown, Function A calls Library E in step 490 and Library E is then fetched and loaded and running on host processor 106, at which time control is passed from Function A to the other Library E (via Path 6). At this time, SMM memory page access control hardware 450 blocks Path 7 according to memory page permissions table/s 123 (which only permits Library E access to Library E), meaning that Library E cannot access Library F as is the case in the conventional methodology of FIG. 1A. Thus, once control is passed from Function A to Library E (via Path 6), it is not possible for Library E to pass control unintentionally to Library F (path 7) in contrast to the case of conventional methodology of FIG. 1A. Blocking Path 7 prevents malware from being written to exploit path 7 to compromise data or code on the system 100.

It will be understood that the embodiments of FIGS. 2-4 are exemplary only and that other embodiments are possible. For example, in one alternative embodiment, a function/libraries permission table/s 123 may be created and integrated into silicon firmware (e.g., embedded hardware microcode 107) of a host processor 106 together with information such as desired configuration of memory page permissions table/s 123 and logic of how to read these table/s 123 upon SMM initialization. In another embodiment, function/libraries permission table/s 123 and accompanying logic function/libraries permission table/s 123 may be included as part of the logic of the host processor 106. In either case, methodology 400 of FIG. 4 may be implemented by host processor 106 upon SMI occurrence, without the need to map function/libraries permission table/s 123 into embedded hardware microcode 107 of host processor 106 together with information such as desired configuration of memory page permissions table/s 123 and logic of how to read these table/s 123 upon SMM initialization. In yet another embodiment, a SMM handler may be provided to implement logic for managing control flow integrity and SMM memory access control. Such an SMM “handler” may be provided as a routine that controls execution flow in software rather than with hardware microcode 107 of host processing device 106.

It will be understood that the steps of FIGS. 3 and 4 are exemplary only, and that any combination of fewer, additional and/or alternative steps may be employed that are suitable for controlling flow integrity and access to system memory pages during systems management mode (SMM).

It will be understood that one or more of the tasks, functions, or methodologies described herein (e.g., including those described herein for components 106, etc.) may be implemented by circuitry and/or by a computer program of instructions (e.g., computer readable code such as firmware code or software code) embodied in a non-transitory tangible computer readable medium (e.g., optical disk, magnetic disk, non-volatile memory device, etc.), in which the computer program comprising instructions is configured when executed on a processing device in the form of a programmable integrated circuit (e.g., processor such as CPU, controller, microcontroller, microprocessor, ASIC, etc. or programmable logic device “PLD” such as FPGA, complex programmable logic device “CPLD”, etc.) to perform one or more steps of the methodologies disclosed herein. In one embodiment, a group of such processing devices may be selected from the group consisting of CPU, controller, microcontroller, microprocessor, FPGA, CPLD and ASIC. The computer program of instructions may include an ordered listing of executable instructions for implementing logical functions in an information handling system or component thereof. The executable instructions may include a plurality of code segments operable to instruct components of an information handling system to perform the methodologies disclosed herein.

It will also be understood that one or more steps of the present methodologies may be employed in one or more code segments of the computer program. For example, a code segment executed by the information handling system may include one or more steps of the disclosed methodologies. It will be understood that a processing device may be configured to execute or otherwise be programmed with software, firmware, logic, and/or other program instructions stored in one or more non-transitory tangible computer-readable mediums (e.g., data storage devices, flash memories, random update memories, read only memories, programmable memory devices, reprogrammable storage devices, hard drives, floppy disks, DVDs, CD-ROMs, and/or any other tangible data storage mediums) to perform the operations, tasks, functions, or actions described herein for the disclosed embodiments.

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touch screen and/or a video display. The information handling system may also include one or more buses operable to transmit communications between the various hardware components.

While the invention may be adaptable to various modifications and alternative forms, specific embodiments have been shown by way of example and described herein. However, it should be understood that the invention is not intended to be limited to the particular forms disclosed. Rather, the invention is to cover all modifications, equivalents, and alternatives falling within the spirit and scope of the invention as defined by the appended claims. Moreover, the different aspects of the disclosed methods and systems may be utilized in various combinations and/or independently. Thus, the invention is not limited to only those combinations shown herein, but rather may include other combinations.

What is claimed is:

1. An information handling system, comprising:
a system memory; and
a programmable integrated circuit coupled to the system memory, the programmable integrated circuit being programmed to operate in a system management mode (SMM) to retrieve and execute at least one SMI function/library from the system memory upon entry into the SMM;
where the programmable integrated circuit is programmed to control access by the executing SMI function/library to data or code regions of the system memory according to a data permission listing that identifies one or more permitted system memory page ranges for which the executing SMI function/library is permitted access, the permitted system page ranges including only a portion of all SMI functions/libraries held in the system memory.

2. The information handling system of claim 1, where the permitted system memory page ranges exclude host kernel and user data regions of the system memory.

3. The information handling system of claim 1, where the data permission listing comprises a memory page table that identifies different permitted system memory page ranges for different respective SMI functions/libraries.

4. The information handling system of claim 1, where the system memory comprises volatile memory; where the information handling system further comprises non-volatile memory coupled to the programmable integrated circuit and the system memory; and where the data permission listing is stored as part of system basic input/output system (BIOS) on system non-volatile memory.

5. The information handling system of claim 4, where the stored system BIOS includes:
one or more SMI functions and/or libraries; and
a data listing identifying specific system volatile memory page ranges for which different respective SMI functions and libraries are to be permitted access, the data listing specifying at least one of the SMI functions or libraries as being permitted access to a first memory page range, the data listing specifying at least one other of the SMI functions or libraries as not being permitted access to the first memory page range.

6. The information handling system of claim 4, where the data permission listing is predefined and stored as part of the system BIOS during manufacture or assembly of the information handling system.

7. The information handling system of claim 1, where the programmable integrated circuit comprises a central processing unit (CPU) that includes embedded microcode hardware, and where the programmable integrated circuit is programmed to use the embedded microcode hardware to control access by the executing SMI function/library to data or code regions of the system memory.

8. The information handling system of claim 7, where the programmable integrated circuit is programmed to execute a system basic input/output system (BIOS) to map the data permission listing into the embedded microcode hardware during system pre-boot; and where the embedded microcode hardware is programmed to respond to entry into SMM to control access by the executing SMI function/library to data or code regions of the system memory for the duration of the SMM.

9. The information handling system of claim 7, where the programmable integrated circuit is programmed to operate in a non-SMM mode during normal operating system runtime, and to respond to receipt of a first system management interrupt (SMI) by:
entering a first SMM mode, and loading and executing a first SMI function or library corresponding to the first SMM;
then using the embedded microcode hardware to control access by the executing SMI function/library to a first data or code region of the system memory according to the data permission listing during the first SMM; and
then exiting the first SMM mode and returning to the normal operating system runtime.

10. The information handling system of claim 7, where the programmable integrated circuit is programmed to respond to receipt of a second system management interrupt (SMI) by:
entering a second SMM different from the first SMM mode, and loading and executing a second SMI function or library corresponding to the second SMM and different from the first SMI function or library; and
then using the embedded microcode hardware to control access by the executing SMI function/library to a second data or code region of the system memory according to the data permission listing during the second SMM, the second data or code region being different than the first data or code region.

11. A method, comprising operating a programmable integrated circuit of an information handling system in a system management mode (SMM) to:
retrieve and execute at least one SMI function/library from a system memory of the information handling system upon entry into the SMM; and
control access by the executing SMI function/library to data or code regions of the system memory according to a data permission listing that identifies one or more permitted system memory page ranges for which the executing SMI function/library is permitted access, the permitted system page ranges including only a portion of all SMI functions/libraries held in the system memory.

12. The method of claim 11, where the permitted system memory page ranges exclude host kernel and user data regions of the system memory.

13. The method of claim 11, where the data permission listing comprises a memory page table that identifies different permitted system memory page ranges for different respective SMI functions/libraries.

14. The method of claim 11, where the system memory comprises volatile memory; where the information handling system further comprises non-volatile memory coupled to the programmable integrated circuit and the system memory; and where the data permission listing is stored as part of system basic input/output system (BIOS) on system non-volatile memory.

15. The method of claim 14, where the stored system BIOS includes:
one or more SMI functions and/or libraries; and
a data listing identifying specific system volatile memory page ranges for which different respective SMI functions and libraries are to be permitted access, the data listing specifying at least one of the SMI functions or libraries as being permitted access to a first memory page range, the data listing specifying at least one other of the SMI functions or libraries as not being permitted access to the first memory page.

16. The method of claim 14, further comprising defining and storing the data permission listing on system non-volatile memory as part of the system BIOS during manufacture or assembly of the information handling system.

17. The method of claim 11, where the programmable integrated circuit comprises a central processing unit (CPU) that includes embedded microcode hardware; and where the method further comprises controlling access by the executing SMI function/library to data or code regions of the system memory using the embedded microcode hardware of the programmable integrated circuit.

18. The method of claim 17, further comprising operating the programmable integrated circuit to execute a system basic input/output system (BIOS) to map the data permission listing into the embedded microcode hardware during system pre-boot; and responding to entry into SMM mode by using the embedded microcode hardware to control access by the executing SMI function/library to data or code regions of the system memory for the duration of the SMM mode.

19. The method of claim 17, further comprising operating the programmable integrated circuit in a non-SMM during normal operating system runtime, and to respond to receipt of a first system management interrupt (SMI) by:
entering a first SMM mode, and loading and executing a first SMI function or library corresponding to the first SMM;
then using the embedded microcode hardware to control access by the executing SMI function/library to a first data or code region of the system memory according to the data permission listing during the first SMM mode; and
then exiting the first SMM and returning to the normal operating system runtime.

20. The method of claim 17, further comprising operating the programmable integrated circuit to respond to receipt of a second and different system management interrupt (SMI) by:
entering a second SMM different from the first SMM, and loading and executing a second SMI function or library corresponding to the second SMM and different from the first SMI function or library; and
then using the embedded microcode hardware to control access by the executing SMI function/library to a second data or code region of the system memory according to the data permission listing during the second SMM, the second data or code region being different than the first data or code region.
